(19) United States
(12) Patent Application Publication
(10) Pub. No.: US 2007/0005781 A1
(43) Pub. Date: Jan. 4, 2007

(54) Method and system for using confirmation objects to substantiate statements in documents

(76) Inventors: Herman Rodriguez, Austin, TX (US); Newton James Smith JR., Austin, TX (US); Clifford Jay Spinac, Austin, TX (US)

Correspondence Address: Greg Goshorn, P.C., 9600 Escarpment, auite 745-9, AUSTIN, TX, 78749, US

(21) Appl. No.: 11/171,759

(22) Filed: Jun. 30, 2005

(51) Int. Cl. G06F 15/16

(52) U.S. Cl. 709/229

(57) ABSTRACT

A computer-implemented method is provided for use of a confirmation object by a reviewing computer to determine the accuracy of statements in a received document. The reviewing computer receives a document containing a statement and a confirmation object associated with the statement. The confirmation object includes a hyperlink to a substantiation object residing on a web page on a server computer. The reviewing computer reads the statement. The reviewing computer actuates the confirmation object, thereby transmitting a request to the server computer that the web page containing the substantiation object be served to the reviewing computer. The reviewing computer receives the web page containing the substantiation object from the server computer, reads the substantiation object, and compares the statement with the substantiation object in order to ascertain their degree of agreement. A substantiation authority system including a server computer is also provided for substantiating statements in a document.

### TECHNICAL FIELD

The present invention relates generally to verifying statements in documents and, more specifically, to a method and system for using confirmation objects to substantiate statements in documents.

### BACKGROUND OF THE INVENTION

International Business Machines Corp. (IBM) of Armonk, N.Y. has been at the forefront of new paradigms in business computing. Accordingly, IBM has been significantly involved in creating and managing processes and systems for processing and transmitting electronic documents. Over time, it has become common for documents to be transmitted electronically. Many such documents are résumés, job applications, and the like. In the case of the latter documents, as well as others, the frequency of inaccuracies, such as false claims, has been increasing.

A common approach to addressing the rising trend in false claims and other inaccurate statements has been to substantiate the statements manually. In the case of résumé claims, for example, former employers and universities are often telephoned and asked to confirm dates of employment and degrees conferred, respectively. Manual substantiation is quite costly in terms of time and effort and is prone to manual errors.

What is needed is a method and system for substantiating statements in documents which is less costly and more accurate than manual substantiation.

### SUMMARY OF THE INVENTION

A computer-implemented method is provided for use of a confirmation object by a reviewing computer to determine the accuracy of statements in a received document. The reviewing computer receives a document containing a statement and a confirmation object associated with the statement. The confirmation object includes a hyperlink to a substantiation object residing on a web page on a server computer. The reviewing computer reads the statement. The reviewing computer actuates the confirmation object, thereby transmitting a request to the server computer that the web page containing the substantiation object be served to the reviewing computer. The reviewing computer receives the web page containing the substantiation object from the server computer, reads the substantiation object, and compares the statement with the substantiation object in order to ascertain their degree of agreement.

A substantiation authority system including a server computer is also provided for substantiating statements in a document. The server computer includes a web page and an object group. The object group includes a substantiation object residing on the web page and a confirmation object that includes a hyperlink adapted to transmit, in response to actuation, a request to the server computer for the web page. The confirmation object is associable with a statement enabling a possessor of the statement to actuate the hyperlink to obtain the web page in order to compare the statement and the substantiation object. The server computer is configured to, in response to receiving a request from a reviewing computer, serve the web page to the reviewing computer.

### BRIEF DESCRIPTION OF THE DRAWINGS

A better understanding of the present invention can be obtained when the following detailed description of the disclosed embodiments is considered in conjunction with the following drawings, in which:

FIG. 1 is a flowchart of a method for use by a reviewing computer to determine the accuracy of statements in a received document, in accordance with an embodiment of the present invention.

FIG. 2 is a flowchart of an alternate method for use by a reviewing computer to determine the accuracy of statements in a received document, in which the confirmation object comprises a digital certificate and enables access to a web page comprising a substantiation object, in accordance with an embodiment of the present invention.

FIG. 3 is a flowchart of another alternate method for use by a reviewing computer to determine the accuracy of statements in a received document, in which a substantiation object comprises a digital signature, in accordance with an embodiment of the present invention.

FIG. 4 is a flowchart of another alternate method for use by a reviewing computer to determine the accuracy of statements in a plurality of received documents, in accordance with an embodiment of the present invention.

FIG. 5 is a flowchart of another alternate method for use by a reviewing computer to determine, in a selected language, the accuracy of statements in a received document, in accordance with an embodiment of the present invention.

FIG. 6 is a block diagram of a substantiation authority system for substantiating statements in a document, wherein a substantiation object resides on a web page, in accordance with an embodiment of the present invention.

FIG. 7 is a block diagram of an alternate substantiation authority system for substantiating statements in a document, wherein a substantiation object resides within the confirmation object, in accordance with an embodiment of the present invention.

FIG. 8 is a block diagram of another alternate substantiation authority system for substantiating statements in a document, wherein a substantiation object resides within the document, but not within the confirmation object, in accordance with an embodiment of the present invention.

FIG. 9 is a block diagram of another alternate substantiation authority system for substantiating statements in a document, in which a plurality of substantiation objects, each in a different language, reside on a trusted host, in accordance with an embodiment of the present invention.

FIG. 10 is a block diagram of another alternate substantiation authority system for substantiating statements in a document, wherein a substantiation object in a particular language and a language translator reside on a trusted host, in accordance with an embodiment of the present invention.

FIG. 11 is a block diagram of a general purpose computer, in accordance with an embodiment of the present invention.

### DETAILED DESCRIPTION OF THE FIGURES

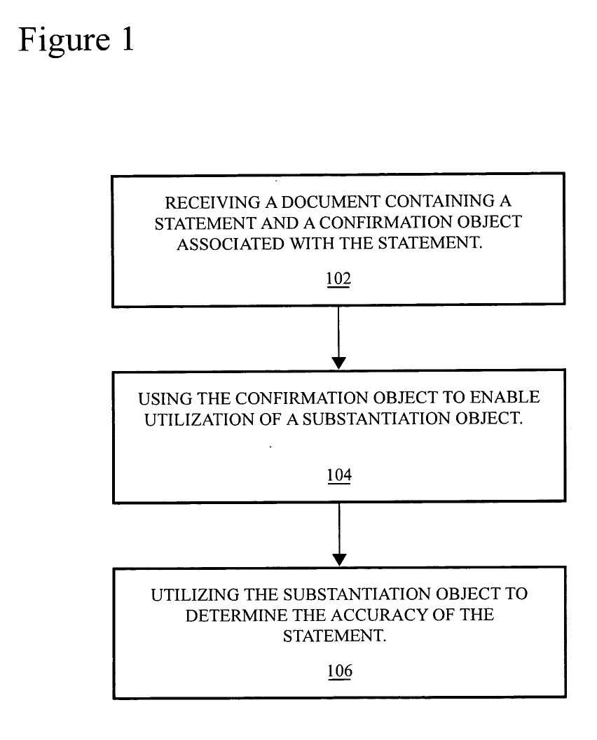

Turning now to the figures, FIG. 1 is a flowchart of an exemplary method for use by a reviewing computer to determine the accuracy of statements in an electronically received document. The reviewing computer electronically receives the document 102. The document contains at least one statement associated with at least one confirmation object, the use of which enables utilization of a substantiation object. The reviewing computer uses 104 the confirmation object, thereby enabling utilization of the substantiation object. The purpose and function of the substantiation object is to enable the reviewing computer to determine the accuracy of the statement. Accordingly, the reviewing computer utilizes 106 the substantiation object to determine the statement's accuracy.

A “statement” may be any verifiable information. Furthermore, a statement can include more than one element of such information. For example, a statement could include not only the university from which a degree was earned, but also identify the specific degree earned, as well as dates of attendance and graduation. Moreover, a statement can include an entire document section (e.g., the education section in a résumé), or even the entire content of a document. Semantically, a set of statements could therefore be considered either as multiple statements or a single statement.

Depending upon the specific implementation of the present invention, a “substantiation object” may contain public or private records, news or other content, or a hyperlink, uniform resource name, or other gateway, connection to, pointer to, or container for relevant content. Accordingly, “utilization” of a given substantiation object is context-specific. For example, a publisher may allow its archived news content to be linked to, but not to be copied and distributed in substantiation objects. The specific content linked to, provided by, or otherwise accessed by utilizing a substantiation object can vary tremendously based on the requirements of the specific implementation of the present invention. For example, such content could include high school academic and extracurricular activities.

Depending upon the embodiment in question, a substantiation object could contain a single supporting fact. Alternately, a substantiation object could contain multiple supporting facts, substantively related (e.g., date of graduation and degree earned) or not (e.g., news stories mentioning the subject matter in question but otherwise unrelated or government agency records pertaining to education and driving history). By way of further example of the latter, a substantiation object could provide information about a job seeker's former employment obtained from a former employer, as well as from the Social Security Administration—the latter, of course, being contingent upon all legal requirements being met, such as a waiver of privacy signed by the job seeker.

In addition, a substantiation object can include facts which do not support full and certain determination of the statement's accuracy, but do provide relevant information which might be helpful to a reviewer. For example, where a former employer has ceased to exist (e.g., due to merging into another company, bankruptcy, or other dissolution) without leaving complete employee information, a substantiation object could provide information that the company existed at the time of claimed employment.

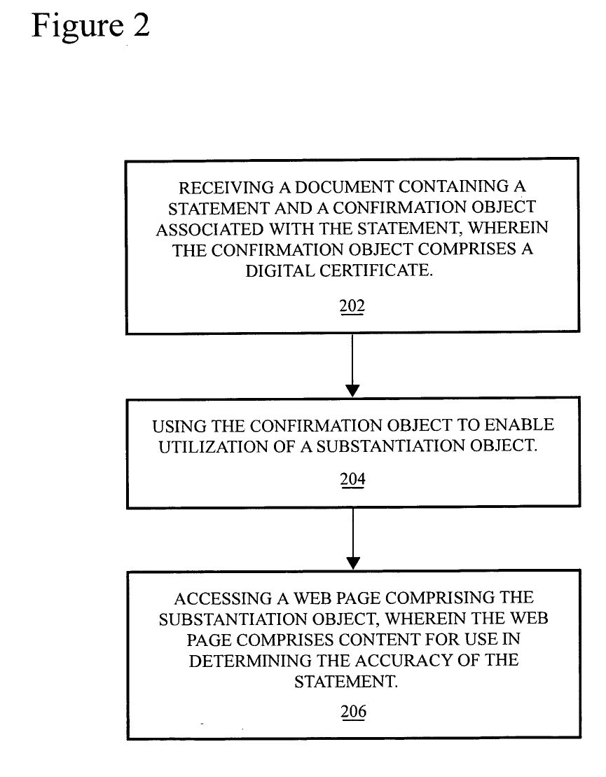

FIG. 2 is a flowchart of an alternate exemplary method for use by a reviewing computer to determine the accuracy of statements in a received document. The reviewing computer receives 202 an electronic document containing a statement and a confirmation object associated with the statement. The confirmation object comprises a digital certificate. The reviewing computer uses 204 the confirmation object to enable utilization of a substantiation object. In utilizing the substantiation object, the reviewing computer access 206 a web page comprising the substantiation object, including content for use in determining the accuracy of the statement, and compares the statement with the web page content (e.g., using a routine in Perl). The access connection to the web page may be encrypted or otherwise secured.

A digital certificate conventionally includes the owner's public key, and serves as a “seal” which can be verified by the issuing certificate authority. Accordingly, a digital certificate conventionally includes the identity of the issuing authority, as well as stating the identity of the owner. Furthermore, digital certificates conventionally include a validity period, often one year. Finally, digital certificates are tamper proof and impervious to forgery, at least to a commercially satisfactory degree. The security aspects of digital certificates generally result from a scheme by which a change to any part of a digital certificate necessarily changes the issuing authority's digital signature as well, thereby invalidating the digital certificate.

In some embodiments, the confirmatory content provided by a substantiation object is secured by use of digital certificate(s). In one such case, a public key infrastructure scheme is used to secure the content. A group of entities (e.g., S&P 500 companies) are provided with a shared private key, while the corresponding public key is made available for securing content to be accessible only to the entities in the group. In an alternate case, the confirmation object is needed to unlock the substantiation object for utilization by a reviewer, thereby hindering collection of confirmatory content by the public (e.g., by unauthorized individuals or spiders crawling the public network).

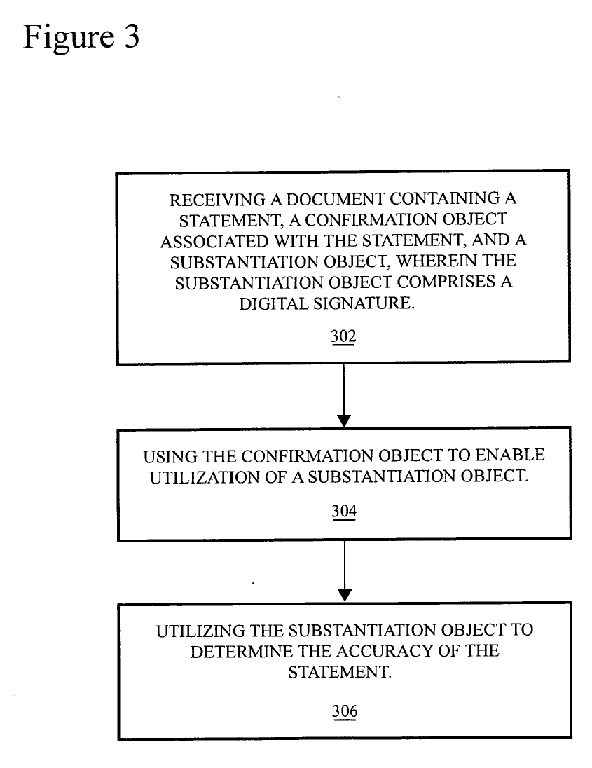

FIG. 3 is a flowchart of another alternate exemplary method for use by a reviewing computer to determine the accuracy of statements in a received document. The reviewing computer electronically receives 302 a document containing a statement, a confirmation object associated with the statement, and a substantiation object. The substantiation object comprises a digital signature. The reviewing computer uses 304 confirmation object to enable utilization of a substantiation object and utilizes 306 the substantiation object to determine the accuracy of the statement.

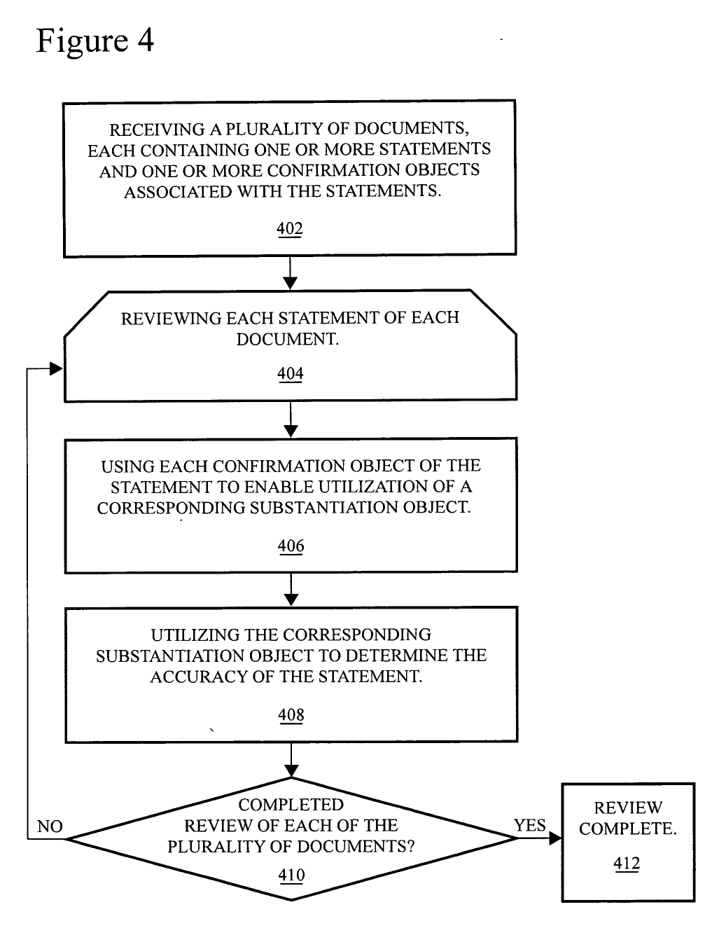

FIG. 4 is a flowchart of another alternate exemplary method for use by a reviewing computer to determine the accuracy of statements in a received document. The reviewing computer electronically receives 402 a plurality of documents, each containing one or more statements and one or more confirmation objects associated with the statements. The reviewing computer reviews 404 each statement of each electronic document. The reviewing computer uses 406 each confirmation object of the statement to enable utilization of a corresponding substantiation object. The reviewing computer utilizes 408 the corresponding substantiation object to determine the accuracy of the statement. The reviewing computer repeats 410 the process, (a) reviewing 404 each statement, (b) using 406 each confirmation object, and (c) utilizing 408 each substantiation object, until each of the plurality of documents is completed 412.

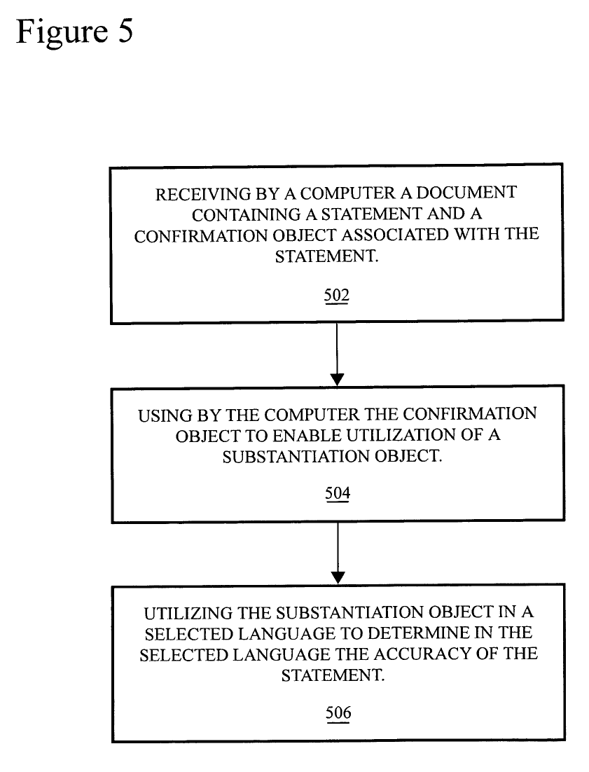

FIG. 5 is a flowchart of another alternate exemplary method for use by a reviewing computer of a confirmation object to determine the accuracy of statements in a received document. The reviewing computer receives 502 an electronic document containing a statement and a confirmation object associated with the statement. The reviewing computer uses 504 the confirmation object (e.g., hyperlink) to utilize a substantiation object (e.g., access educational records via the Internet). The reviewing computer utilizes the substantiation object 506 in a selected language (e.g., automatically translate non-English educational records into English) to determine in the selected language the accuracy of the statement (e.g., using intelligent agent-based executable program).

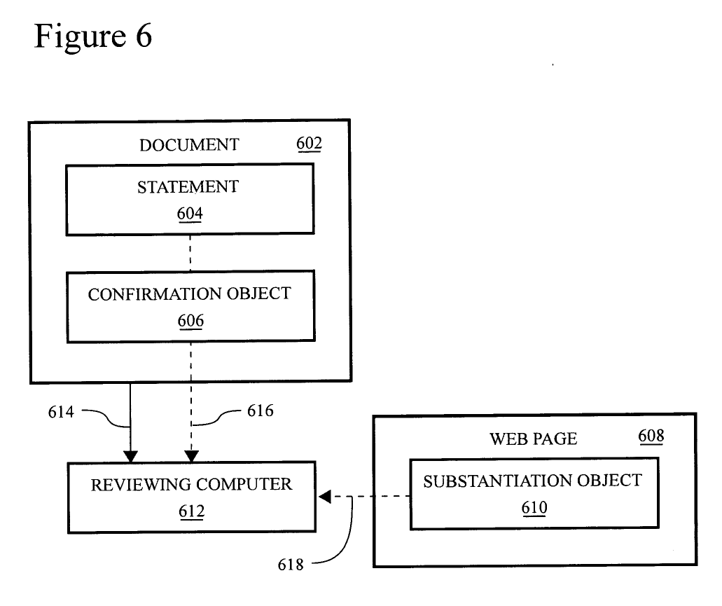

FIG. 6 is a block diagram of an exemplary substantiation authority system for substantiating statements in a document. An electronic document 602 includes a statement 604 and a confirmation object 606 associated with the statement 604. A web page 608 includes a substantiation object 610. A reviewing computer 612 receives 614 the document 602. The reviewer 612 uses 616 the confirmation object 606, which enables the reviewer to utilize 618 the substantiation object 610 to determine the accuracy of the statement 604 under review.

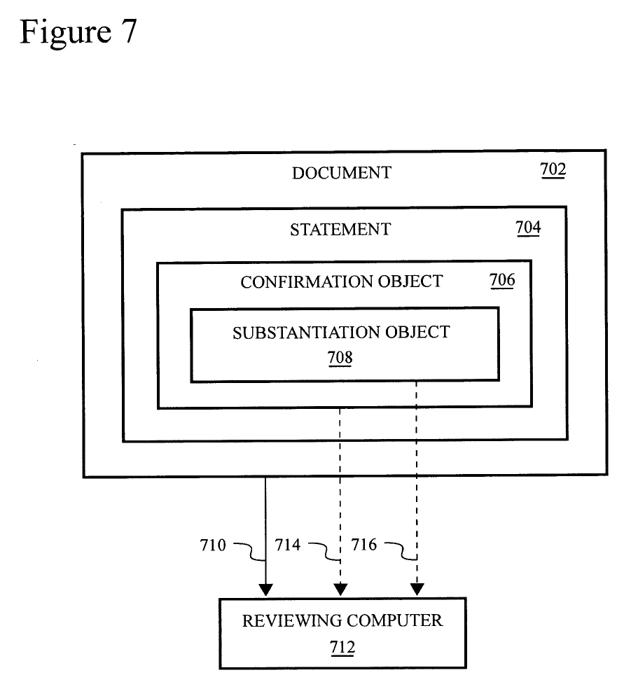

FIG. 7 is a block diagram of an alternate exemplary substantiation authority system for substantiating statements in a document. A document 702 includes a statement 704. The statement 704 includes a confirmation object 706 associated with the statement 704. The confirmation object 706 includes a substantiation object 708. A reviewing computer 712 receives 710 the document 702. The reviewing computer 712 uses 714 the confirmation object 706, which enables the reviewing computer 712 to utilize 716 the substantiation object 708 to determine the accuracy of the statement 704 under review.

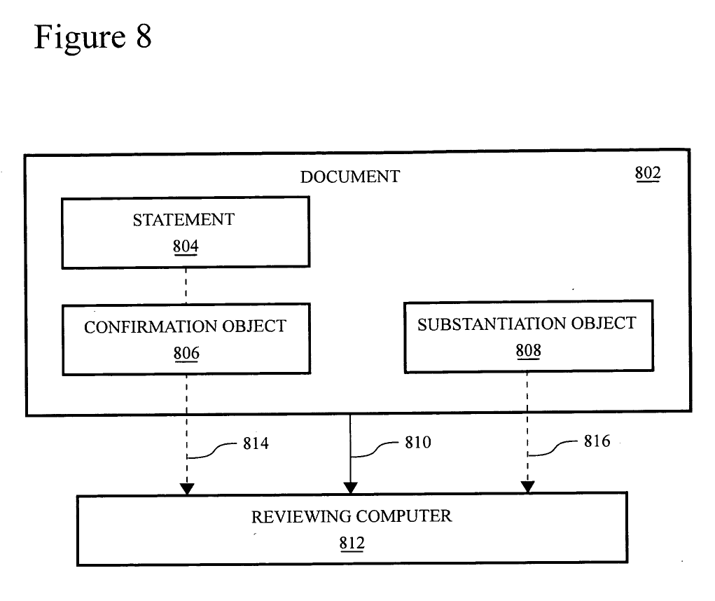

FIG. 8 is a block diagram of another alternate exemplary substantiation authority system for substantiating statements in a document. A document 802 includes a statement 804, a confirmation object 806 associated with the statement 804, and a substantiation object 808. A reviewing computer 812 receives 810 the electronic document 802. The reviewer 812 uses 814 confirmation object 806, which enables the reviewer 812 to utilize 816 the substantiation object 808 to determine the accuracy of the statement 804 under review.

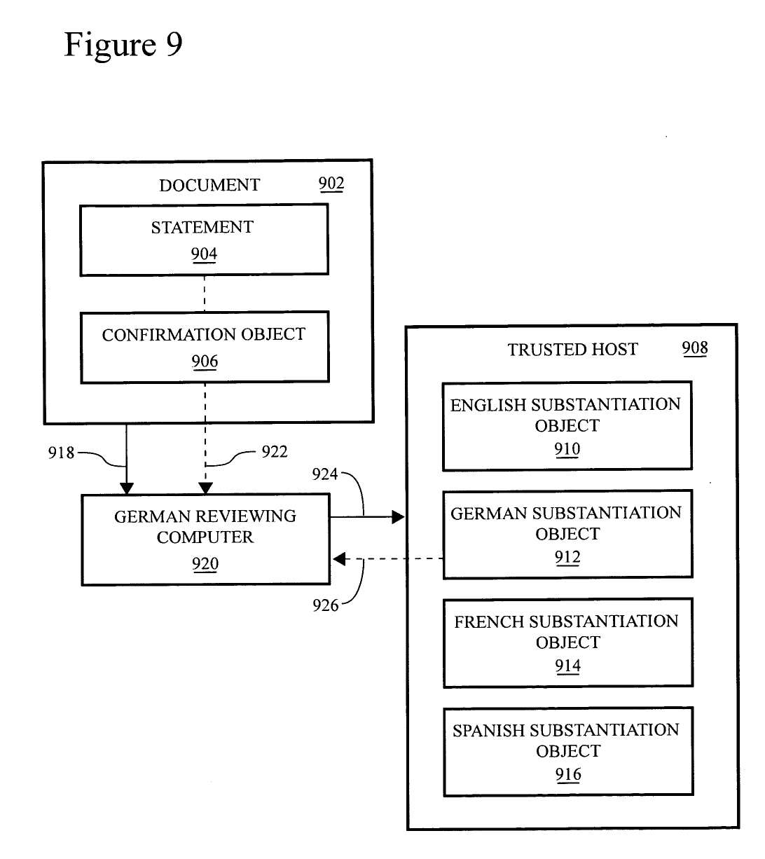

FIG. 9 is a block diagram of another alternate exemplary substantiation authority system for substantiating statements in a document. An electronic document 902, prepared by a job seeker (not shown), serves as the job seeker's résumé. As is conventionally the case with such documents, the résumé 902 includes a statement 904 as to the job seeker's educational credentials. In particular, the statement 904 asserts that that job seeker is named Joe Smith and graduated from the University of Texas in 2003 with a B.S. degree in Chemistry. The statement 904 has the following XML format:

<language> English </language>
...
<education> <institution> University of Texas </institution> <degree>
<type> B.S. </type> <subject> Chemistry </subject> <year>
2003 </year> </degree><confirmation object> http://www.utexas.edu/
joesmith/substantiate/degree/german </confirmation object> </education>

The job seeker forwards the résumé 902 by electronic mail 918 to a German reviewing computer 920, which is a server computer of a human resources department within a Germany-based company by which the job seeker wishes to be considered for employment. The résumé 902 also includes a confirmation object 906, namely a hyperlink to a secure web page hosted by a trusted host 908, in this case, Verisign. The hyperlink 906 is associated with the statement 904 and is intended to be actuated 922 by the German reviewing computer 920 to facilitate substantiation of the statement's accuracy. In particular, the trusted host 908 contains four substantiation objects 910, 912, 914, and 916, respectively formatted in English, German, French, and Spanish. In this example, the job seeker has chosen to link the confirmation object 906 to the German substantiation object 912 because his target employer is a German-based company. Each of the substantiation objects 910-916 include XML-formatted data which can be read by a computer and compared to XML-formatted statements in the résumé to determine whether and to what extent discrepancies appear between the statement and corresponding substantiation object. In this example, the substantiation objects 910-916 are in the following XML formats:

Substantiation Object 910:
<language> English </language>
...
<education> <institution> University of Texas </institution> <degree> <type> B.S.
</type> <subject> Chemistry </subject> <year> 2003 </year> </degree>
</education>
Substantiation Object 912:
<language> German </language>
...
<education> <institution> University of Texas </institution> <degree> <type> B.S.
</type> <subject> Chemie </subject> <year> 2003 </year> </degree>
</education>
Substantiation Object 914:
<language> French </language>
...
<education> <institution> University of Texas </institution> <degree> <type> B.S.
</type> <subject> Chimie </subject> <year> 2003 </year> </degree>
</education>
Substantiation Object 916:
<language> Spanish </language>
...
<education> <institution> University of Texas </institution> <degree> <type> B.S.
</type> <subject> Quimica </subject> <year> 2003 </year> </degree>
</education>

Once the document 902 is received 918 by the German reviewing computer 920, the German reviewing computer 920 uses 922 the confirmation object 906 by executing the hyperlink and sending an electronic request 924 to the trusted host 908 for the substantiation object—web page 912 in this example—associated with the hyperlink 906. In response, the trusted host 908 serves 926 the German substantiation object 912 to the German reviewing computer 920, so the German reviewing computer 920 can utilize the substantiation object 912 by comparing the data it contains to the data contained in the statement 904. The connection between the German reviewing computer 920 and the trusted host 908 can be secured by encryption or other conventional means. Likewise, the connection 918 by which the job seeker sends the résumé 902 to the German reviewing computer 920 may be secured by encryption or other conventional mechanism(s).

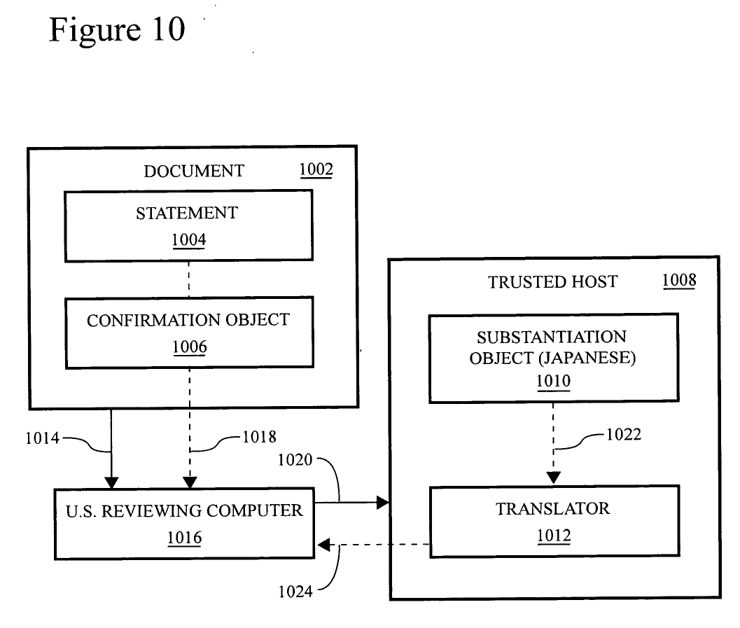

FIG. 10 is a block diagram of another alternate exemplary substantiation authority system for substantiating statements in a document. A document 1002 includes a statement 1004 and a confirmation object 1006 associated with the statement 1004. A trusted host 1008 includes a substantiation object 1010 associated with the Japanese language. A reviewing computer 1016 in the United States receives 1014 the document 1002. The reviewing computer 1016 uses 1018 the confirmation object 1006, which enables the reviewer 1016 to utilize the substantiation object 1010 associated with the Japanese language by sending a substantiation request 1020 to the trusted host 1008, specifying a preference indicator for the English language. In response, the trusted host 1008 provides 1022 the substantiation object 1010 associated with the Japanese language to a translator 1012 for translation into the English language and then provides 1024 the substantiation object 1010 to the reviewer 1016.

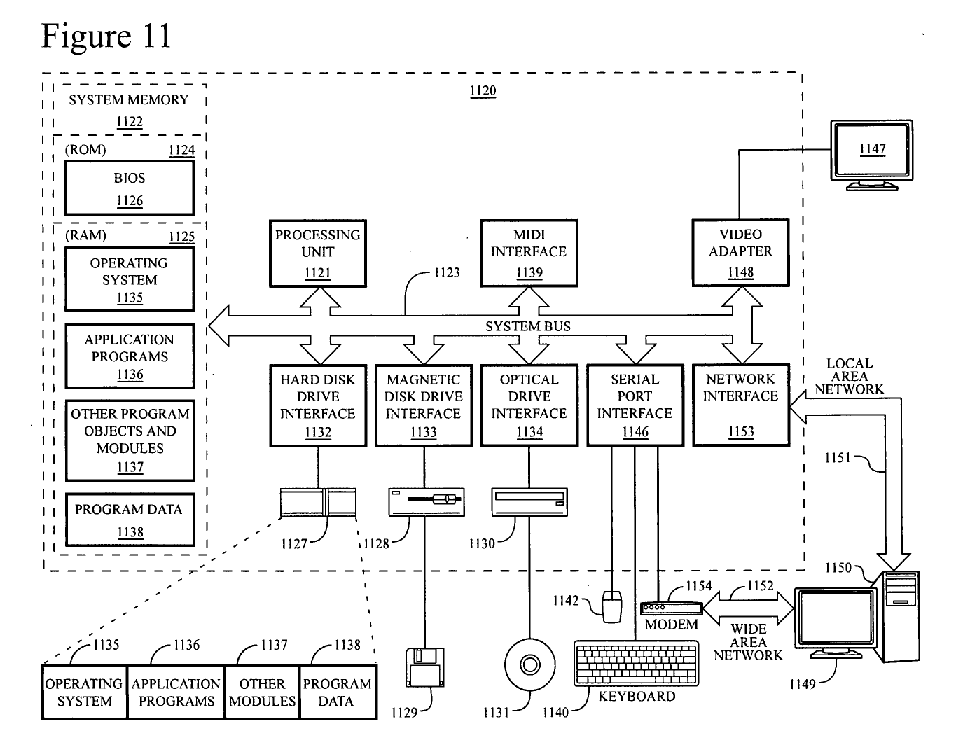

Although described with particular reference to several systems for using confirmation objects to substantiate statements in documents, the claimed subject matter can be implemented in any information technology (IT) system in which substantiating statements in a document using confirmation objects is desirable. FIG. 11 is a block diagram illustrating a general-purpose computer capable of performing, according to some embodiments of the present invention, one or more of the described method steps. In addition, the methods of the disclosed invention can be implemented in software, hardware, or a combination of software and hardware. The hardware portion can be implemented using specialized logic; the software portion can be stored in a memory and executed by a suitable instruction execution system.

The invention may be practiced with other computer system configurations, including hand-held devices, multiprocessor systems, microprocessor-based or programmable consumer electronics, network personal computers (PCs), minicomputers, mainframe computers, and the like. The invention may also be practiced in distributed computer environments where tasks are performed by remote processing devices that are linked through a communications network. In a distributed computer environment, program modules may be located in both local and remote memory storage devices.

An exemplary system for implementing the invention includes a general purpose computer 1120, including a microprocessor or other processing unit 1121, a system memory 1122, and a system bus 1123 that couples various system components including the system memory to the processing unit 1121. In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory and recording medium also include, but are not limited to, for example the following: a portable computer diskette, a random access memory (RAM), a read-only memory (ROM), an erasable programmable read-only memory (EPROM or flash memory), and a portable compact disk read-only memory (CD-ROM) or another suitable medium upon which a program and/or data may be stored.

The system bus 1123 may be any of several types of bus structures including a memory bus or memory controller, a peripheral bus, and a local bus using any of a variety of bus architectures. The system memory includes ROM 1124 and RAM 1125. A basic input/output system 1126 (BIOS), containing the basic routines that help to transfer information between elements within personal computer 1120, such as during start-up, is stored in ROM 1124. The personal computer 1120 further includes a hard disk drive 1127 for reading from and writing to a hard disk, not shown, a magnetic disk drive 1128 for reading from or writing to a removable magnetic disk 1129, and an optical disk drive 1130 for reading from or writing to a removable optical disk 1131 such as a CD-ROM or other optical media. The hard disk drive 1127, magnetic disk drive 1128, and optical disk drive 1130 are connected to the system bus 1123 by a hard disk drive interface 1132, a magnetic disk drive interface 1133, and an optical drive interface 1134, respectively. The drives and their associated computer-readable media provide nonvolatile storage of computer readable instructions, data structures, program modules and other data for the personal computer 1120. Although the exemplary environment described herein employs a hard disk 1127, a removable magnetic disk 1129 and a removable optical disk 1131, it should be appreciated by those skilled in the art that other types of computer readable media which can store data that is accessible by a computer, such as magnetic cassettes, flash memory cards, digital video disks, Bernoulli cartridges, RAMs, ROMs, and the like, may also be used in the exemplary operating environment.

RAM 1125 forms executable memory, which is defined herein as physical, directly-addressable memory that a microprocessor accesses at sequential addresses to retrieve and execute instructions. This memory can also be used for storing data as programs execute.

A number of programs and/or program modules may be stored on the hard disk, magnetic disk 1129 optical disk 1131, ROM 1124, or RAM 1125, including an operating system 1135, one or more application programs 1136, other program objects and modules 1137, and program data 1138. A user may enter commands and information into the personal computer 1120 through input devices such as keyboard 1140 and pointing device 1142. Other input devices (not shown) may include a microphone, joystick, game pad, satellite dish, scanner, or the like. These and other input devices are often connected to the processing unit 1121 through a serial port interface 1146 that is coupled to the system bus, but may be connected by other interfaces, such as a parallel port, game port, or a universal serial bus (USB). A monitor 1147 or other type of display device is also connected to the system bus 1123 via an interface, such as a video adapter 1148. In addition to the monitor, personal computers typically include other peripheral output devices (not shown) such as speakers and printers.

Computer 1120 includes a musical instrument digital interface (MIDI) component 1139 that provides a means for the computer to generate music in response to MIDI-formatted data. In many computers, such a MIDI component is implemented in a “sound card,” which is an electronic circuit installed as an expansion board in the computer. The MIDI component responds to MIDI events by playing appropriate tones through the speakers of the computer.

The personal computer 1120 may operate in a networked environment using logical connections to one or more remote computers, such as a remote computer 1149. The remote computer 1149 may be another personal computer, a server, a router, a network PC, a peer device or other common network node, and typically includes many or all of the elements described above relative to the personal computer 1120, although only a memory storage device 1150 has been illustrated in FIG. 11. The logical connections depicted in FIG. 11 include a local area network (LAN) 1151 and a wide area network (WAN) 1152. Such networking environments are commonplace in offices, enterprise-wide computer networks, intranets, and the Internet.

When used in a LAN networking environment, the personal computer 1120 is connected to the local network 1151 through a network interface or adapter 1153. When used in a WAN networking environment, the personal computer 1120 typically includes a modem 1154 or other means for establishing communications over the wide area network 1152, such as the Internet. The modem 1154, which may be internal or external, is connected to the system bus 1123 via the serial port interface 1146. In a networked environment, program modules depicted relative to the personal computer 1120, or portions thereof, may be stored in the remote memory storage device. It will be appreciated that the network connections shown are exemplary and other means of establishing a communications link between the computers may be used.

Generally, the data processors of computer 1120 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described below. Furthermore, certain sub-components of the computer may be programmed to perform the functions and steps described below. The invention includes such sub-components when they are programmed as described.

For purposes of illustration, programs and other executable program components such as the operating system are illustrated herein as discrete blocks, although it is recognized that such programs and components reside at various times in different storage components of the computer, and are executed by the data processor(s) of the computer. Familiarity with object based programming, and with COM objects in particular, is assumed throughout this disclosure.

The following example illustrates another alternate embodiment of the present invention. A company creates a human resources website to provide verified employment information on present or former employees. A present or former employee accesses the website and chooses from a list of items the company will verify (e.g., dates of employment, salary, evaluation information, and terms of departure) which the employee wants made available to reviewing entities (e.g., prospective employers, mortgage companies, or agencies providing a security clearance). In this example, the employee has the freedom to make fewer than all of the items available.

The website then provides to the employee, possibly for a fee, a link which the reviewing entity can use to obtain the available information. The link could be provided in the form of an icon provided to the employee, which he or she could attach to a document (e.g., an electronic résumé or job application). This service could also be provided through a trusted third-party (e.g., Verisign). Reviewing entities (e.g., prospective employers, mortgage companies, or agencies providing a security clearance) benefit from a quick, easy, and secure way to verify applicant information. The applicant benefits from quicker processing of his or her application.

The term “received,” as used herein, includes, in addition to its ordinary meaning, the following additional meanings: (1) accessed, downloaded, or captured as from a web page (e.g., Monster.com or Hotjobs.com), (2) received via electronic mail, and (3) electronically captured (e.g., keyed in or optically scanned) from paper records or otherwise obtained from records in a different medium. In the latter instance, a confirmation object could be associated with each statement to be substantiable using a conventional automatic or manual means.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order. For example, a translator such as that shown in FIG. 10 could be located externally to a trusted host. By way of further example, a translator such as that shown in FIG. 10 could accompany a substantiation object embedded in a document.

We claim:

1. A computer-implemented method for use of a confirmation object by a reviewing computer to determine the accuracy of statements in a received document, the method comprising:
receiving by the reviewing computer a document containing a statement and a confirmation object associated with the statement, wherein the confirmation object comprises a hyperlink to a substantiation object residing on a web page on a server computer;
reading by the reviewing computer the statement;
actuating by the reviewing computer the confirmation object, thereby transmitting a request to the server computer that the web page containing the substantiation object be served to the reviewing computer;
receiving by the reviewing computer the web page containing the substantiation object from the server computer;
reading by the reviewing computer the substantiation object;
comparing by the reviewing computer the statement with the substantiation object in order to ascertain their degree of agreement.

2. The method of claim 1, further comprising:
establishing by the reviewing computer an encrypted Internet connection with the server computer.

3. The method of claim 1, wherein the substantiation object comprises a digital signature.

4. The method of claim 1, wherein the confirmation object comprises a digital certificate.

5. The method of claim 1,
wherein the receiving by the reviewing computer the document comprises receiving by the reviewing computer a plurality of documents, each containing a statement and a confirmation object associated with the statement;
wherein the method further comprises:
repeating, for each statement of each document, the following reviewing steps:
reading by the reviewing computer the current statement;
actuating by the reviewing computer the current confirmation object associated with the current statement, thereby transmitting a current request to the server computer that a current web page containing the corresponding substantiation object be served to the reviewing computer;
receiving by the reviewing computer the current web page containing the corresponding substantiation object from the server computer;
reading by the reviewing computer the corresponding substantiation object;
comparing by the reviewing computer the current statement with the corresponding substantiation object in order to ascertain their degree of agreement.

6. The method of claim 1, wherein the utilizing the substantiation object comprises:
utilizing the substantiation object in a selected language to determine in the selected language the accuracy of the statement.

7. The method of claim 1, wherein the receiving comprises:
converting the document containing the statement from a first medium to a second medium;
associating a confirmation object with the statement.

8. A computer programming product for substantiating statements received by a reviewing computer, comprising:
a memory;
logic, stored on the memory, for:
receiving by the reviewing computer a document containing a statement and a confirmation object associated with the statement, wherein the confirmation object comprises a hyperlink to a substantiation object residing on a web page on a server computer;
reading by the reviewing computer the statement;
actuating by the reviewing computer the confirmation object, thereby transmitting a request to the server computer that the web page containing the substantiation object be served to the reviewing computer;
receiving by the reviewing computer the web page containing the substantiation object from the server computer;
reading by the reviewing computer the substantiation object;
comparing by the reviewing computer the statement with the substantiation object in order to ascertain their degree of agreement.

9. The product of claim 8, wherein the logic for utilizing the substantiation object further comprises logic, stored on the memory, for:
establishing by the reviewing computer an encrypted Internet connection with the server computer.

10. The product of claim 8, wherein the substantiation object comprises a digital signature.

11. The product of claim 8, wherein the confirmation object comprises a digital certificate.

12. The product of claim 8,
wherein the logic for receiving by the reviewing computer the document comprises logic, stored on the memory, for receiving by the reviewing computer a plurality of documents, each containing a statement and a confirmation object associated with the statement;
wherein the product further comprises logic, stored on the memory, for:
repeating, for each statement of each document, the following reviewing steps:
reading by the reviewing computer the current statement;
actuating by the reviewing computer the current confirmation object associated with the current statement, thereby transmitting a current request to the server computer that a current web page containing the corresponding substantiation object be served to the reviewing computer;
receiving by the reviewing computer the current web page containing the corresponding substantiation object from the server computer;
reading by the reviewing computer the corresponding substantiation object;
comparing by the reviewing computer the current statement with the corresponding substantiation object in order to ascertain their degree of agreement.

13. The product of claim 8, further comprising logic, stored on the memory, for:
transmitting by the reviewing computer, with the request to the server computer that the web page containing the substantiation object be served to the reviewing computer, a preferred language indicator.

14. The product of claim 8, wherein the logic for receiving by the reviewing computer the document further comprises logic, stored on the memory, for:
converting the document containing the statement from a first medium to a second medium;
associating the confirmation object with the statement.

15. A substantiation authority system for substantiating statements in a document, the system comprising:
a server computer including:
a web page;
an object group including:
a substantiation object residing on the web page,
a confirmation object comprising a hyperlink adapted to transmit, in response to actuation, a request to the server computer for the web page,
wherein the confirmation object is associable with a statement enabling a possessor of the statement to actuate the hyperlink to obtain the web page in order to compare the statement and the substantiation object;
wherein the server computer is configured to, in response to receiving a request from a reviewing computer, serve the web page to the reviewing computer.

16. The system of claim 15,
wherein the server computer is adapted to establish a secure connection with the reviewing computer over the Internet for communicating the request for and serving of the web page.

17. The system of claim 15, wherein the substantiation object includes a configuration which provides access only to a selected portion of its contents.

18. The system of claim 15, wherein the substantiation object comprises a digital signature.

19. The system of claim 15,
wherein the hyperlink includes a language preference parameter;
wherein the server computer further includes a second web page;
wherein the object group further includes a second substantiation object composed from a second language residing on the second web page;
wherein the hyperlink is further adapted to transmit, in response to actuation, if the language preference parameter is the second language, a request to the server computer for the second web page;
wherein the confirmation object is further associable with the statement enabling the possessor of the statement to actuate the hyperlink to obtain, if the language preference parameter is the second language, the second web page in order to compare the statement and the second substantiation object;
wherein the server computer is configured to, in response to receiving a request, including the second language as the language preference parameter, from a reviewing computer, serve the second web page to the reviewing computer.

20. The system of claim 15,
wherein the hyperlink includes a language preference parameter;
wherein the substantiation object comprises content associated with a first language;
wherein the system further comprises a translator adapted to translate, in response to receiving a request with the language preference parameter of the second language, the substantiation object from the first language to a second language.
